(19) United States
(12) Patent Application Publication
(10) Pub. No.: US 2024/0130375 A1
(43) Pub. Date: Apr. 25, 2024

(54) MILDEW-PROOF COMPOSITE COMPOSITION WITH SYNERGISTIC EFFECT AS WELL AS PREPARATION METHOD AND APPLICATION THEREOF

(71) Applicant: Institute of Microbiology, Guangdong Academy of Sciences(Guangdong Detection Center of Microbiology), Guangzhou (CN)

(72) Inventors: Xiaobao XIE, Guangzhou (CN); Dezan LIU, Guangzhou (CN); Wenru LI, Guangzhou (CN); Zhiqing ZHANG, Guangzhou (CN)

(73) Assignee: Institute of Microbiology, Guangdong Academy of Sciences(Guangdong Detection Center of Microbiology), Guangzhou (CN)

(21) Appl. No.: 18/391,725

(22) Filed: Dec. 21, 2023

(30) Foreign Application Priority Data
Sep. 20, 2022 (CN) 202211146154.2

(51) Int. Cl. A01N 65/08; A01N 65/24; A01P 3/00

(52) U.S. Cl. CPC A01N 65/08; A01N 65/24; A01P 3/00

(57) ABSTRACT

A mildew-proof composite composition with a synergistic effect as well as a preparation method and application thereof is provided. The mildew-proof composite composition includes the following components in volume fraction: 10 to 50% of cinnamon essential oil, and 50 to 90% of mustard essential oil. The mildew-proof composite composition with the synergistic effect provided by the present invention is blended into a composite essential oil composition with a significant inhibitory effect and strong antibacterial effect through the interactions among the components.

### CROSS REFERENCE TO THE RELATED APPLICATIONS

This application is based upon and claims priority to Chinese Patent Application No. CN 202211146154.2, filed on Sep. 20, 2022, the entire contents of which are incorporated herein by reference.

### TECHNICAL FIELD

The present invention belongs to the field of essential oils, in particular to a mildew-proof composite composition with a synergistic effect as well as a preparation method and application thereof.

### BACKGROUND

Plant essential oils, also known as essential oils, are natural bioactive ingredients extracted from plants, have received more and more attention and are widely developed and utilized because of their unique odor and inhibitory and antimicrobial effects, and also have the characteristics of convenient materials because of abundant genera and species of essential oils contained in natural plants, thus being more important in everyday applications.

Plant essential oils are natural ingredients, and their production and metabolism have already had a mature cycle pathway, but the development and utilization of plant essential oils will not cause hidden dangers to the environment. Due to the large use of chemical agents, the problem of bacterial resistance is becoming increasingly difficult. Plant essential oils are complex mixtures, containing dozens or even hundreds of components. Fungi are difficult to produce resistance, and at the same time have become one of the important sources of green inhibitory and antimicrobial agents because of their characteristics of high volatility, low residue, etc.

Cinnamon essential oil is obtained from fresh branches and leaves, stems and barks of Chinese cassia tree of Lauraceae plants by extracting with a steam distillation method and refining by fumigation.

Mustard essential oil is obtained by grinding mustard seeds, mixing them with water, and extracting the resulting volatile oil by distillation.

### SUMMARY

An object of the present invention is to provide a mildew-proof composite composition with a synergistic effect as well as a preparation method and application thereof. The mildew-proof composite composition of the present invention has a high-efficiency inhibitory effect to make up for the deficiency of low inhibitory performance of a single essential oil.

The inhibitory effects of plant essential oils are usually determined by their main components, and there may also be synergistic effects among different components. Two or more single essential oils are mixed in proportion to obtain a composite essential oil. The additive or synergistic effects of different plant essential oils can significantly improve their inhibitory effects. Therefore, the composite essential oil has significant advantages over single essential oils.

The present invention provides a mildew-proof composite composition with a synergistic effect, which includes the following components in volume fraction: 10 to 50% of cinnamon essential oil, and 50 to 90% of mustard essential oil.

Further preferably, a volume ratio of the cinnamon essential oil to the mustard essential oil in the mildew-proof composite composition with the synergistic effect is 1:(1-5). Further preferably, a volume ratio of the cinnamon essential oil to the mustard essential oil in the mildew-proof composite composition with the synergistic effect is 1:(3-5).

A second object of the present invention is to provide a preparation method of the mildew-proof composite composition with the synergistic effect. The mildew-proof composite composition is obtained by mixing cinnamon essential oil and mustard essential oil uniformly.

The preparation method specifically includes the following steps:
S1, selecting a plurality of blending appliances of appropriate sizes needed for blending composite essential oils;
S2, selecting the types of essential oils, calculating a total volume, adding the essential oils into the blending appliances for mixing according to corresponding proportions, and mixing the essential oils to obtain a blended composite essential oil with a uniform composition;
S3, labeling the surfaces of the blending appliances, and specifying the types of composite essential oils and the proportions of various added essential oils on the labels; and
S4, storing the blended essential oils in a cool place.

Preferably, each blending appliance for the blended composite essential oil is a dark glass bottle which is used for storing the corresponding essential oil conveniently.

A third object of the present invention is to provide an application of the mildew-proof composite composition with the synergistic effect in the preparation of a mildew-proof agent.

Preferably, the mildew-proof agent is an agent resistant to Aspergillus niger, Trichoderma viridis or Penicillium chrysogenum.

For example, the mildew-proof composite composition with the synergistic effect is applied in fields of light industries such as food, textiles, and leather products.

Compared with an application of a single essential oil, the present invention has the following beneficial effects.

1. The mildew-proof composite composition with the synergistic effect provided by the present invention is blended into a composite essential oil composition with a significant inhibitory effect and strong antibacterial effect through the interactions among the components, which has a good application prospect, so as to make up for the deficiency of low inhibitory performance of a single essential oil.

2. The preparation method of the mildew-proof composite composition with the synergistic effect provided by the present invention is simple, easy to operate, suitable for large-scale industrial production, and high in production efficiency.

3. The application of the mildew-proof composite composition with the synergistic effect provided by the present invention provides products with antimicrobial and inhibitory effects for different fields, and meets the needs of different industries.

### DETAILED DESCRIPTION OF THE EMBODIMENTS

The following examples are further illustrations of the present invention, rather than limitations to the present invention.

The cinnamon essential oil in the following embodiment was purchased from Sangon Bioengineering (Shanghai) Co., Ltd., having a catalog number A501966.

The mustard essential oil in the following embodiment was purchased from Shanghai Yuanye Biotechnology Co., Ltd., having a catalog number S27503.

A flat plate in the following embodiment is purchased from Nantong Baiyao Experimental Equipment Co., Ltd., having an article number YJ-C-90, and a specification of 90*15 mm.

### Embodiment 1

Spores of Aspergillus niger, Trichoderma viridis and Penicillium chrysogenum in a medium were eluted with sterile water with 0.05% Tween 80, filtered with multi-layer gauze and then added to a flat plate, and then added with 20 ml of potato dextrose agar (PDA) medium containing a fixed amount of a mildew-proof composite composition having an synergistic effect, such that a final spore concentration in the medium was (1-3)×10⁵ cfu/ml; a volume ratio of cinnamon essential oil to mustard essential oil in the mildew-proof composite composition with the synergistic effect was set to be 1:1 (in the preparation method, the cinnamon essential oil and the mustard essential oil are mixed according to a volume ratio of 1:1); concentration gradients were set to be 0.0078 μl/ml, 0.0156 μl/ml, 0.03125 μl/ml, 0.0625 μl/ml, and 0.125 μl/ml; and a minimum inhibitory concentration of the mildew-proof composite composition with the synergistic effect was determined, with 3 replicates for each concentration. When the determination results showed that the cinnamon essential oil was mixed with the mustard essential oil, the minimum inhibitory concentrations for the Aspergillus niger and the Trichoderma viridis in the three molds were both 0.03125 μl/ml, and the minimum inhibitory concentration for the Penicillium chrysogenum was 0.03125 μl/ml.

### Embodiment 2

Spores of Aspergillus niger, Trichoderma viridis and Penicillium chrysogenum in a medium were eluted with sterile water with 0.05% Tween 80, filtered with multi-layer gauze and then added to a flat plate, and then added with 20 ml of potato dextrose agar (PDA) medium containing a fixed amount of a mildew-proof composite composition having an synergistic effect, such that a final spore concentration in the medium was (1-3)×10⁵ cfu/ml; a ratio of cinnamon essential oil to mustard essential oil in the mildew-proof composite composition with the synergistic effect was set to be 1:3 (in the preparation method, the cinnamon essential oil and the mustard essential oil are mixed according to a volume ratio of 1:3); concentration gradients were set to be 0.0078 μl/ml, 0.0156 μl/ml, 0.03125 μl/ml, 0.0625 μl/ml, and 0.125 μl/ml; and a minimum inhibitory concentration of the mildew-proof composite composition with the synergistic effect was determined, with 3 replicates for each concentration. When the determination results showed that the cinnamon essential oil was mixed with the mustard essential oil, the minimum inhibitory concentration for the Aspergillus niger was 0.03125 μl/ml; the minimum inhibitory concentration for the Trichoderma viridis was 0.125 μl/ml; and the minimum inhibitory concentration for the Penicillium chrysogenum was 0.03125 μl/ml.

### Embodiment 3

Spores of Aspergillus niger, Trichoderma viridis and Penicillium chrysogenum in a medium were eluted with sterile water with 0.05% Tween 80, filtered with multi-layer gauze and then added to a flat plate, and then added with 20 ml of potato dextrose agar (PDA) medium containing a fixed amount of a mildew-proof composite composition having an synergistic effect, such that a final spore concentration in the medium was (1-3)×10⁵ cfu/ml; a ratio of cinnamon essential oil to mustard essential oil in the mildew-proof composite composition with the synergistic effect was set to be 3:1 (in the preparation method, the cinnamon essential oil and the mustard essential oil are mixed according to a volume ratio of 3:1); concentration gradients were set to be 0.0078 μl/ml, 0.0156 μl/ml, 0.03125 μl/ml, 0.0625 μl/ml, and 0.125 μl/ml; and a minimum inhibitory concentration of the mildew-proof composite composition with the synergistic effect was determined, with 3 replicates for each concentration. When the determination results showed that the cinnamon essential oil was mixed with the mustard essential oil, the minimum inhibitory concentration for the Aspergillus niger was 0.125 μl/ml; the minimum inhibitory concentrations for the Trichoderma viridis and the Penicillium chrysogenum were 0.0625 μl/ml respectively.

### Embodiment 4

Spores of Aspergillus niger, Trichoderma viridis and Penicillium chrysogenum in a medium were eluted with sterile water with 0.05% Tween 80, filtered with multi-layer gauze and then added to a flat plate, and then added with 20 ml of potato dextrose agar (PDA) medium containing a fixed amount of a mildew-proof composite composition having an synergistic effect, such that a final spore concentration in the medium was (1-3)×10⁵ cfu/ml; a ratio of cinnamon essential oil to mustard essential oil in the mildew-proof composite composition with the synergistic effect was set to be 1:5 (in the preparation method, the cinnamon essential oil and the mustard essential oil are mixed according to a volume ratio of 1:5); concentration gradients were set to be 0.0078 μl/ml, 0.0156 μl/ml, 0.03125 μl/ml, 0.0625 μl/ml, and 0.125 μl/ml; and a minimum inhibitory concentration of the mildew-proof composite composition with the synergistic effect was determined, with 3 replicates for each concentration. When the determination results showed that the cinnamon essential oil was mixed with the mustard essential oil, the minimum inhibitory concentrations for the Aspergillus niger and the Penicillium chrysogenum were 0.03125 μl/ml respectively; and the minimum inhibitory concentration for the Trichoderma viridis was 0.125 μl/ml.

### Embodiment 5

Spores of Aspergillus niger, Trichoderma viridis and Penicillium chrysogenum in a medium were eluted with sterile water with 0.05% Tween 80, filtered with multi-layer gauze and then added to a flat plate, and then added with 20 ml of potato dextrose agar (PDA) medium containing a fixed amount of a mildew-proof composite composition having an synergistic effect, such that a final spore concentration in the medium was (1-3)×10⁵ cfu/ml; a ratio of cinnamon essential oil to mustard essential oil in the mildew-proof composite composition with the synergistic effect was set to be 5:1 (in the preparation method, the cinnamon essential oil and the mustard essential oil are mixed according to a volume ratio of 5:1); concentration gradients were set to be 0.0078 μl/ml, 0.0156 μl/ml, 0.03125 μl/ml, 0.0625 μl/ml, and 0.125 μl/ml; and a minimum inhibitory concentration of the mildew-proof composite composition with the synergistic effect was determined, with 3 replicates for each concentration. When the determination results showed that the cinnamon essential oil was mixed with the mustard essential oil, the minimum inhibitory concentration for the Aspergillus niger was 0.125 μl/ml; and the minimum inhibitory concentrations for the Trichoderma viridis and the Penicillium chrysogenum were 0.0625 μl/ml respectively.

### Comparative Embodiment 1

Spores of Aspergillus niger, Trichoderma viridis and Penicillium chrysogenum in a medium were eluted with sterile water with 0.05% Tween 80, filtered with multi-layer gauze and then added to a flat plate, and then added with 20 ml of potato dextrose agar (PDA) medium containing a fixed amount of single cinnamon essential oil, such that a final spore concentration in the medium was (1-3)×10⁵ cfu/ml; concentration gradients were set to be 0.0625 μl/ml, 0.125 μl/ml, 0.25 μl/ml, and 0.5 μl/ml; and a minimum inhibitory concentration of the single cinnamon essential oil was determined, with 3 replicates for each concentration; and minimum inhibitory concentrations of the cinnamon essential oil for three molds were determined.

### Comparative Embodiment 2

Spores of Aspergillus niger, Trichoderma viridis and Penicillium chrysogenum in a medium were eluted with sterile water with 0.05% Tween 80, filtered with multi-layer gauze and then added to a flat plate, and then added with 20 ml of potato dextrose agar (PDA) medium containing a fixed amount of single mustard essential oil, such that a final spore concentration in the medium was (1-3)×10⁵ cfu/ml; concentration gradients were set to be 0.0625 μl/ml, 0.125 μl/ml, 0.25 μl/ml, and 0.5 μl/ml; and a minimum inhibitory concentration of the single cinnamon essential oil was determined, with 3 replicates for each concentration; and minimum inhibitory concentrations of the mustard essential oil for three molds were determined.

The test results in the above embodiments and comparative embodiments are as follows.

The minimum inhibitory concentration (MIC) of the single cinnamon essential oil for the Aspergillus niger was 0.25 μl/ml; the minimum inhibitory concentration for the Trichoderma viridis was 0.125 μl/ml; and the minimum inhibitory concentration for the Penicillium chrysogenum was 0.125 μl/ml.

The minimum inhibitory concentration (MIC) of the single mustard essential oil for the Aspergillus niger was 0.125 μl/ml; the minimum inhibitory concentration for the Trichoderma viridis was 0.125 μl/ml; and the minimum inhibitory concentration for the Penicillium chrysogenum was 0.0625 μl/ml.

The minimum inhibitory concentrations (MIC) of the cinnamon essential oil and the mustard essential oil in the mildew-proof composite composition with the synergistic effect for the Aspergillus niger were 0.03125 μL/mL respectively when mixed according to a ratio of 1:3 and 1:5.

The minimum inhibitory concentrations of the mustard essential oil and the cinnamon essential oil in the mildew-proof composite composition with the synergistic effect for the Trichoderma viridis were 0.125 μL/mL respectively when mixed according to a ratio of 1:3 and 1:5.

The minimum inhibitory concentrations of the cinnamon essential oil and the mustard essential oil in the mildew-proof composite composition with the synergistic effect for the Penicillium chrysogenum were 0.03125 μL/mL respectively when mixed according to a ratio of 1:1, 1:3 and 1:5.

The test results in the above embodiments and comparative embodiments were processed by FIC index analysis.

Evaluation of combined antibacterial effect: the fractional inhibitory concentration (FIC) was used as the basis for judging the effect of combined antibacterial test.

$$FIC index = \frac{{MIC}_{composite essential oil}}{{MIC}_{single essential oil A}} + \frac{{MIC}_{composite essential oil}}{{MIC}_{single essential oil B}} .$$

FIC index judgment criteria:when FIC index was ≤0.5, there was a synergistic effect; when FIC index was 0.5<FIC≤1, there was an additive effect; when FIC index was 1<FIC≤2, there was an irrelevant effect; and when FIC index was >2, there was an antagonistic effect.

Analysis of the results of the minimum inhibitory concentrations of the cinnamon essential oil, the mustard essential oil and the composite essential oil of the cinnamon essential oil and the mustard essential oil (i.e., the mildew-proof composite composition with the synergistic effect): the FIC index was less than or equal to 1, there was an obvious inhibitory enhancement effect; and especially when a volume ratio of the cinnamon essential oil to the mustard essential oil was 1:(1 to 5) (especially 1:(3 to 5), the FIC index was less than ≤0.5, there was a synergistic effect.

The test results showed that the composite essential oil (the mildew-proof composite composition with the synergistic effect) composed of the cinnamon essential oil and the mustard essential oil had excellent anti-mold activities, significantly improved inhibitory effects, and excellent mildew-proof effects on food, textiles, leather products and hardware products. By comparing the antibacterial test results of the embodiments and the comparative embodiments, it could be seen that the antibacterial activity was greatly weakened if one of the essential oil components was missing. It could thus be seen that the essential oil components in the mildew-proof composite composition with the synergistic effect of the present invention were indispensable, and the essential oil components had a significant synergistic effect.

The embodiments of the present invention have been described in detail above, but the present invention is not limited to the described embodiments. For those skilled in the art, various changes, modifications, substitutions and modifications made to these embodiments, without departing from the principle and spirit of the present invention, still fall within the protection scope of the present invention.

What is claimed is:

1. A mildew-proof composite composition with a synergistic effect, comprising the following components in volume fraction: 10 to 50% of cinnamon essential oil, and 50 to 90% of mustard essential oil.

2. The mildew-proof composite composition with the synergistic effect according to claim 1, wherein the mildew-proof composite composition with the synergistic effect is composed of cinnamon essential oil and mustard essential oil according to a volume ratio of 1:(1-5).

3. The mildew-proof composite composition with the synergistic effect according to claim 1, wherein the mildew-proof composite composition with the synergistic effect is composed of cinnamon essential oil and mustard essential oil according to a volume ratio of 1:(3-5).

4. The mildew-proof composite composition with the synergistic effect according to claim 1, 2 or 3, wherein the mildew-proof composite composition is an agent resistant to Aspergillus niger, Trichoderma viridis or Penicillium chrysogenum.

5. A preparation method of the mildew-proof composite composition with the synergistic effect according to claim 1, 2 or 3, wherein the mildew-proof composite composition is obtained by mixing cinnamon essential oil and mustard essential oil uniformly.

6. The preparation method according to claim 5, specifically comprising:
S1, selecting a plurality of blending appliances of appropriate sizes needed for blending composite essential oils;
S2, selecting the types of essential oils, calculating a total volume, adding the essential oils into the blending appliances for mixing according to the corresponding proportions, and mixing the essential oils to obtain a blended composite essential oil, wherein the blended composite essential oil has a uniform composition;
S3, labeling the surfaces of the blending appliances, and specifying the types of composite essential oils and the proportions of various added essential oils on the labels; and
S4, storing the blended composite essential oil in a cool place.

7. The preparation method according to claim 6, wherein in step S4, the blended composite essential oil is stored in a dark glass bottle.

8. A method for preparing a mildew-proof agent comprising the step of adding the mildew-proof composite composition with the synergistic effect according to claim 1 to an appropriate excipient or vehicle.

9. The method according to claim 8, wherein the mildew-proof composite composition is resistant to growth of Aspergillus niger, Trichoderma viridis or Penicillium chrysogenum.
